(19) United States
(12) Patent Application Publication
(10) Pub. No.: US 2026/0051709 A1
(43) Pub. Date: Feb. 19, 2026

(54) PIVOTABLE SENSOR MODULE FOR ENGAGEMENT WITH A SENSOR

(71) Applicant: FCI OEN Connectors Limited, Kochi (IN)

(72) Inventors: Kalloor Mathew Jacob, Kochi (IN); Nirmal Sam Mandumpal Babu, Kochi (IN); Chandresan Binesh, Kochi (IN); Alex Babu Thuruthummalil, Kochi (IN)

(73) Assignee: FCI OEN Connectors Limited, Kochi (IN)

(21) Appl. No.: 19/297,905

(22) Filed: Aug. 12, 2025

(30) Foreign Application Priority Data
Aug. 14, 2024 (IN) 202441061663

(51) Int. Cl. H01R 35/04; G01D 11/30; H01R 12/70; H01R 13/11; H01R 13/506

(52) U.S. Cl. CPC H01R 35/04; H01R 12/7076; H01R 13/113; H01R 13/506; G01D 11/30; H01R 2201/20

(57) ABSTRACT

A sensor module for environmental sensing in an electronic system with a PCB. The sensor module includes a connector for mounting to the PCB that forms a pivotable connection to an interconnect. A sensor may be coupled to the interconnect at an end opposite the connector such that, by pivoting the interconnect relative to the connector, the height of the sensor above the PCB can be adjusted. The sensor module may include features that facilitate ease of use, including receptacles that each securely engages one or more leads of a sensor, a separable cover with openings sized to dictate the number of leads inserted into each opening; features that allow the interconnect to engage the connector in a single orientation and/or features that set the tilt angle of the interconnect relative to the connector.

### CROSS-REFERENCE TO RELATED APPLICATIONS

This application claims priority to and the benefit of Indian Patent Application No. 202441061663, filed on Aug. 14, 2024, entitled “PIVOTABLE SENSOR MODULE FOR ENGAGEMENT WITH A SENSOR.” The contents of these applications are incorporated herein by reference in their entirety

### BACKGROUND

This disclosure relates generally to sensing environmental conditions within an electronic enclosure and, more specifically, to a sensor module for engagement with a sensor.

Sensors may be used to sense characteristics associated with an electronic assembly, such as an electronic assembly that includes a printed circuit board (PCB). The accuracy with which some characteristics are sensed may be affected by the height of the sensor above the PCB. For example, a temperature sensor that is disposed too high above components of the electronic assembly that may be mounted on the PCB may sense a lower temperature than the ambient temperature affecting most of the components. Similarly, a temperature sensor that is disposed too low and close to the PCB (e.g., a surface-mounted sensor) may sense a higher temperature than the ambient temperature due to its proximity to a high-heat dissipating component.

### SUMMARY

According to an aspect of the present disclosure, a sensor module receives a sensor for one or more characteristics associated with an electronic assembly comprising a printed circuit board (PCB). The sensor includes a plurality of leads and the sensor module includes a connector to be mounted on the PCB. The connector includes a connector housing, and a first plurality of conductive elements held by the connector housing, each of the first plurality of conductive elements comprising a tail configured for electrical connection to the PCB and a mating contact portion. The sensor module also includes an interconnect to receive the plurality of leads of the sensor. The interconnect is pivotably coupled to the connector and includes an interconnect housing pivotally coupled to the connector housing, and a second plurality of conductive elements held by the interconnect housing, each of the second plurality of conductive elements comprising a mating contact portion configured to pivotally engage a mating contact portion of a respective conductive element of the first plurality of conductive elements and a receptacle configured to receive at least one lead among the plurality of leads of the sensor.

Optionally, the interconnect comprises a first end and a second end, opposite the first end. The interconnect housing is pivotally coupled to the connector housing at the first end of the interconnect, and the interconnect is configured to receive the sensor at the second end.

Optionally, the interconnect housing has a face at the second end, and the face comprises a plurality of openings, each of the plurality of openings aligned with a respective receptacle of a conductive element of the second plurality of conductive elements.

Optionally, one of the plurality of openings is sized to accommodate one of the plurality of leads of the sensor and another of the plurality of openings is sized to accommodate two or more of the plurality of leads of the sensor.

Optionally, the interconnect housing comprises a body portion and a cover, the body comprises a cavity with the receptacles of the second plurality of conductive elements disposed within the body, and the cover comprises the face.

Optionally, the cover is latched to the body.

Optionally, each of the receptacles of the second plurality of conductive elements comprises at least three sides and each of the mating contact portions of the second plurality of conductive elements comprises a first arm and an opposed second arm. For each of the second plurality of conductive elements, the first arm extends from a first side of the at least three sides of the receptacle to the mating contact portion, the second arm extends from a second side of the at least three sides of the receptacle, opposite the first side, to the mating contact portion, and the receptacle further comprises a tab, configured to engage a sensor lead, cut in a side of the at least three sides of the receptacle.

Optionally, the mating contact portion of each of the second plurality of conductive elements is a portion of the first arm and a portion of the second arm that are closest to each other.

Optionally, the mating contact portion of each of the first plurality of conductive elements is engaged in the mating contact portion of a corresponding one of the second plurality of conductive elements, between the portion of the first arm and the portion of the second arm.

Optionally, the mating contact portion of each of the second plurality of conductive elements rotates around an axis through the mating contact portion of a corresponding one of the first plurality of conductive elements.

Optionally, the interconnect comprises a first connector engagement feature on a first side of the first end of the interconnect, and a second connector engagement feature, of a different size than the first connector engagement feature, on a second side, opposite the first side, of the first end of the interconnect.

Optionally, the connector comprises a first interconnect engagement feature on a first side of the connector, and a second interconnect engagement feature, of a different size than the first interconnect engagement feature, on a second side, opposite the first side, of the connector.

Optionally, the first connector engagement feature is a first disk protruding from a first extending arm of the interconnect housing, and the second connector engagement feature is a second disk, with a smaller diameter than the first disk, protruding from a second extending arm of the interconnect housing.

Optionally, the first interconnect engagement feature is a first groove in a first extending arm of the connector housing, the second interconnect engagement feature is a second groove, smaller than the first groove, in a second extending arm of the connector housing, and each of the first groove and the second groove have an open end and a rounded closed end.

Optionally, the first extending arm of the connector housing flexes to engage the first disk protruding from the first extending arm of the interconnect housing into the open end of the first groove, and the second extending arm of the connector housing flexes to engage the second disk protruding from the second extending arm of the interconnect housing into the open end of the second groove. The second groove is sized such that only the second disk, and not the first disk, engages in the second groove, and the first extending arm and the second extending arm of the interconnect pivot based on respective rotation of the first disk in the first groove and the second disk in the second groove.

According to another aspect of the disclosure, a sensor assembly includes a sensor to sense one or more characteristics associated with an electronic assembly comprising a printed circuit board (PCB), a connector to be mounted on the PCB, and an interconnect to receive the sensor and couple to the connector. The interconnect comprises asymmetrical mating components to couple to the connector in only one orientation, and the interconnect and the sensor tilt relative to the connector.

Optionally, an interconnect housing includes a first extending arm on a first side and a second extending arm on a second side, opposite the first side, of the interconnect housing. A connector housing includes a first extending arm on a first side and a second extending arm on a second side, opposite the first side, of the connector housing. The first extending arm of the interconnect housing couples to the first extending arm of the connector housing and the second extending arm of the interconnect housing couples to the second extending arm of the connector housing.

Optionally, the first extending arm of the interconnect housing includes a first disk that slides into a first groove in the first extending arm of the connector housing and the second extending arm of the interconnect housing includes a second disk that slides into a second groove in the second extending arm of the connector housing, wherein the first disk is larger than the second disk and the second groove is too small to accommodate the first disk.

Optionally, the first groove has an open end and a rounded, closed end, and the first disk slides into the open end of the first groove, and the second groove has an open end and a rounded, closed end, and the second disk slides into the open end of the second groove.

Optionally, the interconnect tilts relative to the connector based on rotation of the first disk at the rounded, closed end of the first groove and on rotation of the second disk at the rounded, closed end of the second groove.

Optionally, the interconnect comprises a first end including the first extending arm and the second extending arm and a second end, opposite the first end. The interconnect housing has a face at the second end, and the face comprises a plurality of openings, each of the plurality of openings aligned with a respective receptacle among a plurality of receptacles, each configured to receive at least one lead among a plurality of leads of the sensor.

Optionally, the connector includes a first plurality of conductive elements, each of the first plurality of conductive elements comprising a tail configured for electrical connection to the PCB and a mating contact portion. The interconnect includes a second plurality of conductive elements, each of the second plurality of conductive elements comprising a mating contact portion configured to pivotally engage a mating contact portion of a respective conductive element of the first plurality of conductive elements and one of the plurality of receptacles.

Optionally, the first extending arm and the second extending arm of the interconnect comprise protruding bumps, and the first extending arm and the second extending arm of the connector comprise holes such that the protruding bumps of the interconnect engage with the holes of the connector to lock the interconnect at a given tilt angle.

Optionally, the sensor is a temperature sensor, humidity sensor, moisture sensor, pressure sensor, or pressure-temperature-altitude sensor.

According to another aspect of the disclosure, a modular assembly to receive a modular component includes a connector configured to be mounted on a printed circuit board (PCB). The connector includes a connector housing comprising a first interface coupler on a first side of the connector housing and a second interface coupler on a second side, opposite the first side, of the connector housing. The modular assembly also includes an interconnect. The interconnect includes a first end configured to be pivotably coupled to the connector, a second end configured to be coupled to the modular component; and an interconnect housing comprising a first connector coupler on a first side of the interface housing and a second connector coupler on a second side, opposite the first side, of the interface housing. The first interconnect coupler of the connector housing is sized to accommodate the first connector coupler of the interface housing and the second interface coupler of the connector housing is sized to accommodate the second connector coupler of the interface housing such that the interface housing is slidably coupled to the connector housing in only one orientation.

Optionally, the first interface coupler is a first groove with an open end and a rounded, closed end and the second interface coupler is a second groove with an open end and a rounded, closed end, and the first connector coupler is a first disk, the second connector coupler is a second disk, smaller than the first disk, and the second groove is too small to accommodate the first disk.

Optionally, the interface housing includes a first extendable arm on a first side and a second extendable arm on a second side, opposite the first side, of the interface housing, and the connector housing includes a first extendable arm on a first side and a second extendable arm on a second side, opposite the first side, of the connector housing.

Optionally, the first disk protrudes from the first extendable arm of the interface housing and the second disk protrudes from the second extendable arm of the interface housing. The first groove is in the first extendable arm of the connector housing and the second groove is in the second extendable arm of the connector housing, and the interface couples to the connector only when the first extendable arm of the interface is aligned with the first extendable arm of the connector and the second extendable arm of the interface is aligned with the second extendable arm of the connector.

Optionally, the interface pivots relative to the connector based on rotation of the first disk in the rounded end of the first groove and rotation of the second disk in the rounded end of the second groove.

Optionally, the first extendable arm and the second extendable arm of the interface include protruding bumps, and the first extending arm and the second extending arm of the connector comprise holes such that the protruding bumps of the interconnect engage with the holes of the connector to lock the interconnect at a given pivot angle.

Optionally, the connector includes a first plurality of conductive elements, each of the first plurality of conductive elements comprising a tail configured for electrical connection to the PCB and a mating contact portion. The interface includes a second plurality of conductive, each of the second plurality of conductive elements comprising a mating contact portion configured to pivotally engage a mating contact portion of a respective conductive element of the first plurality of conductive elements and a receptacle configured to receive at least one lead among the plurality of leads of a sensor coupled to the interconnect.

Optionally, each of the receptacles of the second plurality of conductive elements comprises at least three sides, and each of the mating contact portions of the second plurality of conductive elements comprises a first arm and an opposed second arm. For each of the second plurality of conductive elements, the first arm extends from a first side of the at least three sides of the receptacle to the mating contact portion, the second arm extends from a second side of the at least three sides of the receptacle, opposite the first side, to the mating contact portion, and the receptacle further comprises a tab, configured to engage a sensor lead, cut in a side of the at least three sides of the receptacle.

Optionally, the mating contact portion of each of the second plurality of conductive elements is a portion of the first arm and a portion of the second arm that are closest to each other.

Optionally, the mating contact portion of each of the first plurality of conductive elements is engaged in the mating contact portion of a corresponding one of the second plurality of conductive elements, between the portion of the first arm and the portion of the second arm.

Optionally, the mating contact portion of each of the second plurality of conductive elements rotates around the mating contact portion of a corresponding one of the first plurality of conductive elements.

The foregoing features may be used, separately or together in any combination in any of the foregoing embodiments.

### BRIEF DESCRIPTION OF DRAWINGS

The accompanying drawings are not necessarily drawn to scale. For the purposes of clarity, not every component may be labeled in every drawing. In the drawings:

FIG. 1A is a perspective view of an exemplary sensor assembly;

FIG. 1B is a side view of the sensor assembly of FIG. 1A in an exemplary arrangement in which the interconnect is tilted 45 degrees relative to the connector;

FIG. 1C is a side view of the sensor assembly of FIG. 1A in an exemplary arrangement in which the interconnect is tilted 90 degrees in a first direction relative to the connector;

FIG. 1D is a side view of the sensor assembly of FIG. 1A in an exemplary arrangement in which the interconnect is tilted 90 degrees in a second direction relative to the connector;

FIG. 2 is a perspective view of the sensor assembly of FIG. 1A with the sensor shown decoupled from the interconnect;

FIG. 3 is a perspective view of the sensor module of the sensor assembly of FIG. 1A with the interconnect cover unlatched from the interconnect housing;

FIG. 4A is a perspective view of the sensor module of the sensor assembly of FIG. 1A from a first side, with an interconnect and connector of the sensor module detached;

FIG. 4B is a perspective view of the sensor module of the sensor assembly of FIG. 1A from a second side, with an interconnect and connector of the sensor module detached;

FIG. 5 is a perspective view of the conductive elements of the interconnect of the sensor module of FIG. 1A exploded from the interconnect housing;

FIG. 6A is a top perspective view into a receptacle of a conductive element of the interconnect of FIG. 1A;

FIG. 6B is a front perspective view of a conductive element of the interconnect of FIG. 1A;

FIG. 7 is a perspective view of the connector of the sensor assembly of FIG. 1A;

FIG. 8 is a perspective view of the connector of FIG. 7 with the connector housing removed;

FIG. 9 is a perspective view of electrical connections between the interconnect and the connector, with housings of the interconnect and connector hidden; and

FIG. 10 is a front view of the sensor assembly of FIG. 1A with the interconnect housing and the connector housing hidden.

### DETAILED DESCRIPTION

The inventors have recognized and appreciated sensor module designs that facilitate a wide range of height adjustments for accurate sensing, as well as ease of use through direct modular coupling to a sensor. The sensor module may include a connector electrically connected to the PCB and an interconnect pivotably coupled to the connector. The interconnect may be coupled to a component, such as a sensor.

Such a sensor module supports easy assembly of an environmental sensing system for an electronic assembly including a PCB. The interconnect may include receptacles that couple to one or more leads of a sensor (or other component), for example, without the need for an additional process such as crimping, wiring, or soldering. In some examples, the interconnect may include a cover over the receptacles with openings in the cover through which leads may enter the receptacles. The openings may be sized to enable one, two or other desired number of leads to enter each receptacle. Such a cover may be latched to the interconnect housing such that, by attaching a cover with holes of a specific configuration, the sensor module may be configured for a specific type of sensor or other component.

In addition, pivoting of the interconnect relative to the connector facilitates height adjustment above the PCB for the sensor coupled to the interconnect. This adjustment may be made at any time, including after the sensor module is attached to the PCB. Further, pivoting of the interconnect relative to the connector facilitates the connector height being available as a standoff height for placement of components with heights lower than the standoff height close to the connector, thereby allowing a smaller footprint for the electronic assembly.

In some examples, the connector includes a connector housing holding conductive elements, each with a tail portion facilitating electrical connection to the PCB. The tail portion may be mounted on the PCB, for example, for secure connection. The conductive elements may each additionally include a mating contact portion for electrical connection with the interconnect.

In some examples, the interconnect includes an interconnect housing pivotably coupled to the connector housing. The interconnect housing holds conductive elements, each with a mating portion to pivotably engage with a corresponding mating portion of the conductive elements of the connector. Each of the conductive elements also includes receptacles to receive the leads of sensor. The interconnect housing and the connector may be coupled by asymmetric engagement features to ensure that the interconnect is in the correct orientation when coupled to the connector.

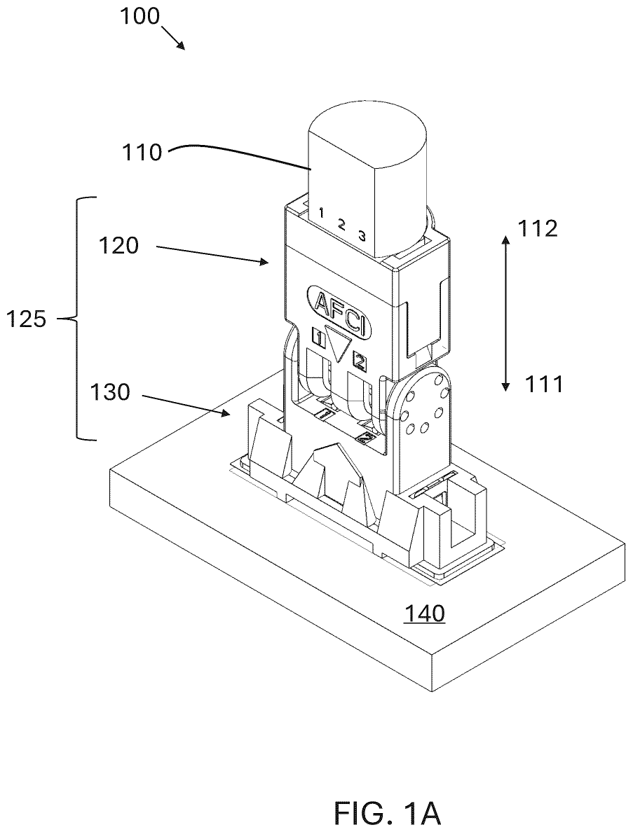

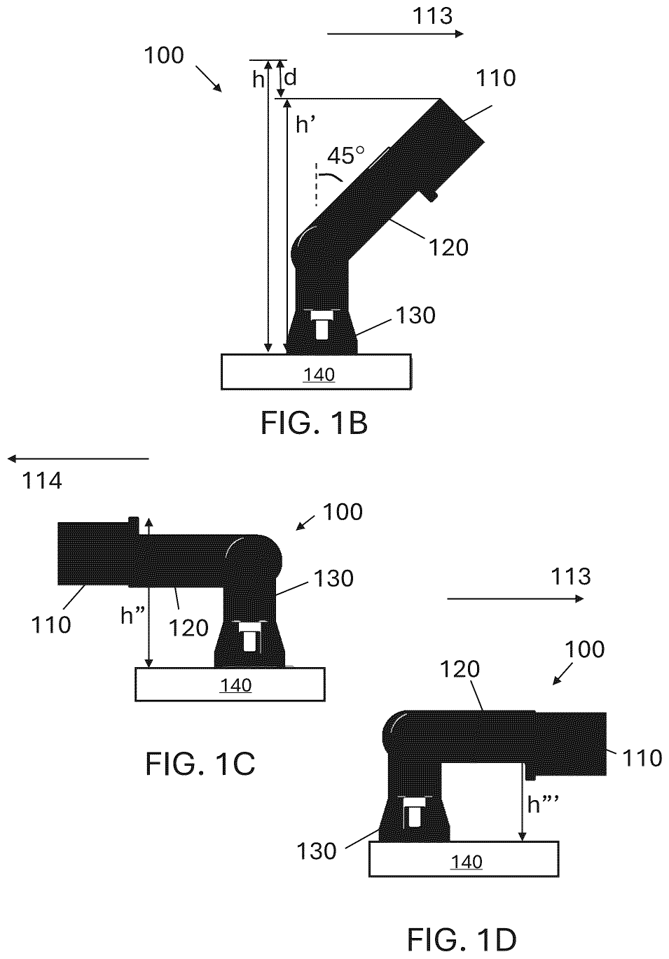

FIGS. 1A, 1B, 1C, and 1D show an exemplary sensor assembly 100 at different tilt angles according to one or more embodiments. FIG. 1A is a perspective view of the sensor assembly 100. The sensor assembly 100 is shown with an exemplary sensor 110 that is removably coupled to a sensor module 125. The sensor module 125 includes a connector 130 connected to a PCB 140 and an interconnect 120 that couples to the connector 130, at a first end 111, and that couples to the sensor 110, at a second end 112 that is opposite the first end 111, as indicated. According to the one or more embodiments, the interconnect 120 is pivotably coupled to the connector 130. In the arrangement illustrated in FIG. 1A, the tilt angle is 0 degrees (0°). Pivot and tilt are used interchangeably to refer to a degree of rotation of the interface 120 (and coupled sensor 110 or other pluggable module) relative to the connector 130. More generally, the sensory assembly 100 is a modular assembly and the sensor module 125 is a modular subassembly, and the sensor 110 may any modular component coupled to the PCB 140 via the interconnect 120 and connector 130 of the modular subassembly.

FIG. 1B shows the sensor assembly 100 in an exemplary arrangement in which the interconnect 120 is tilted 45° relative to the connector 130 in a first direction 113, as indicated. Because the sensor 110 is coupled to the interconnect 120, the tilt of the interconnect 120 relative to the connector 130 results in a change in height of the sensor 110 above the PCB 140. The height of the sensor 110 above the PCB 140 (i.e., distance between the PCB 140 and a point on the sensor 110 that is farthest from the PCB 140) is indicated as h for the arrangement shown in FIG. 1A, in which the tilt angle is 0°. The height h may be on the order of 20 millimeters (mm), for example. The height of the sensor 110 above the PCB 140 is indicated as h′ for the arrangement shown in FIG. 1B, in which the tilt angle is 45°. The height h′ may be on the order of 17.4 mm, for example. That is, the sensor 110 is closer to the PCB 140 by the difference d, which may be on the order of 2.6 mm, when the interconnect 120 is tilted by 45° relative to the connector 130.

FIG. 1C shows the sensor assembly 100 in an exemplary arrangement in which the interconnect 120 is tilted 90° relative to the connector 130 in a second direction 114, which is opposite the first direction 113 indicated in FIG. 1B. Based on the 90° tilt of the interconnect 120 relative to the connector 130 in the second direction, the sensor 110 is even closer to the PCB 140 than it is in FIG. 1B, based on the 45° tilt of the interconnect 120 relative to the connector 130. The height h″ of the sensor 110 may be on the order of 10.2 mm, for example.

FIG. 1D shows the sensor assembly 100 in an exemplary arrangement in which the interconnect 120 is tilted 90° relative to the connector 130 in the first direction 113, which is the same direction in which the interconnect 120 is shown tilted in FIG. 1B. Based on the 90° tilt of the interconnect 120 relative to the connector 130 in the first direction 113, the sensor 110 is even closer to the PCB 140 than it is in FIG. 1C, based on the 90° tilt of the interconnect 120 relative to the connector 130 in the second direction 114. The height h″′ of the sensor 110 may be on the order of 9 mm, for example. The sensor 110 may be closest to the PCB 140 based on the 90° tilt of the interconnect 120 in the first direction 113, while the sensor 110 is farthest from the PCB 140 based on the 0° tilt of the interconnect 120 shown in FIG. 1A.

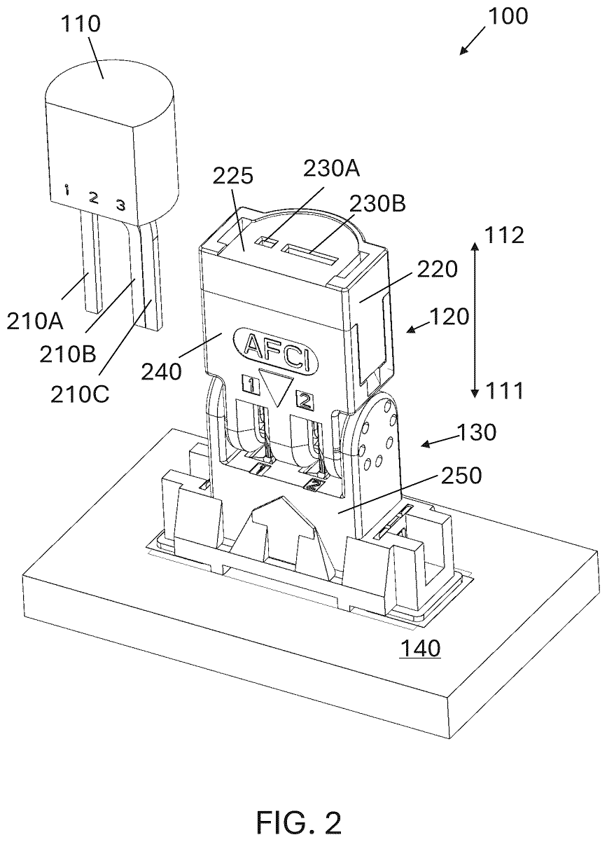

FIG. 2 is a perspective view of the sensor assembly 100 with the sensor 110 shown decoupled from the interconnect 120. The exemplary sensor 110 is shown to have three leads 210A, 210B, and 210C, which may generally be referred to as leads 210. The interconnect 120 has an interconnect cover 220 on the second end 112 that mates with an interconnect housing 240, and the connector 130 has a connector housing 250. The interconnect cover 220 has a face 225 with openings 230A and 230B, generally referred to as openings 230.

As illustrated in FIG. 2, lead 210A of the sensor 110 is separate from leads 210B and 210C. The opening 230A in the interconnect cover 220 is sized for the lead 210A, while the opening 230B is sized for the leads 210B and 210C together. The leads 210 of the sensor 110 enter the openings 230 of the interconnect cover 220 to form an electrical connection between the sensor 110 and the interconnect 120 and, more generally, the sensor module 125. The openings 230 being sized according to corresponding leads 210 may result in a secure coupling between the sensor 110 and the interconnect 120. The sensor 110 plugs into the sensor module 125 through insertion of the leads 210 into the openings 230.

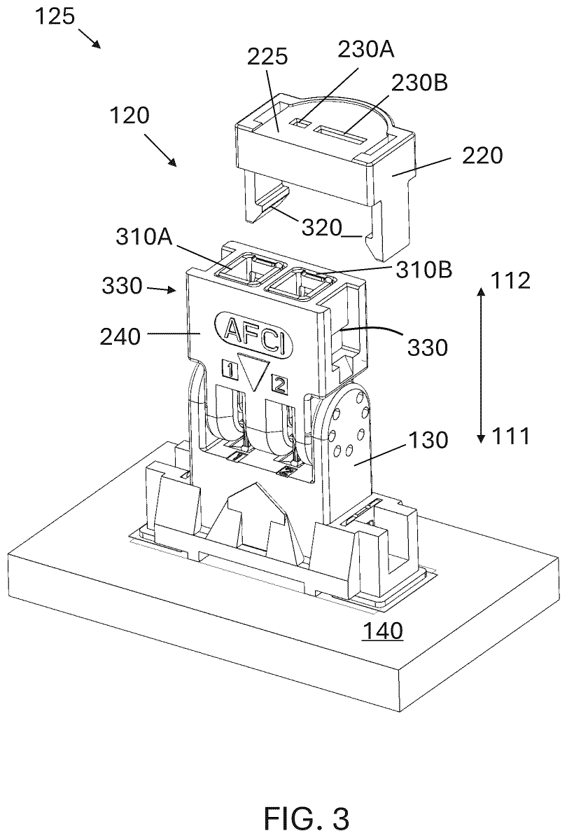

FIG. 3 is a perspective view of the sensor module 125 of the sensor assembly 100 with the interconnect cover 220 unlatched from the interconnect housing 240. The interconnect cover 220 includes hooked arms 320 on opposite sides of the interconnect cover 220 that engage with catches 330 on opposite sides of the interconnect housing 240. With the interconnect cover 220 unlatched and removed from the second end 112 of the interconnect 120, the receptacles 310A, 310B (generally referred to as receptable 310) in the interconnect housing 240 are visible. The receptacles 310A, 310B align with the openings 230A, 230B in the interconnect cover 220. Unlike the openings 230, which may be sized according to the number of leads 210 of the sensor 110 entering each opening 230, the receptacles 310 may be similarly sized, as shown.

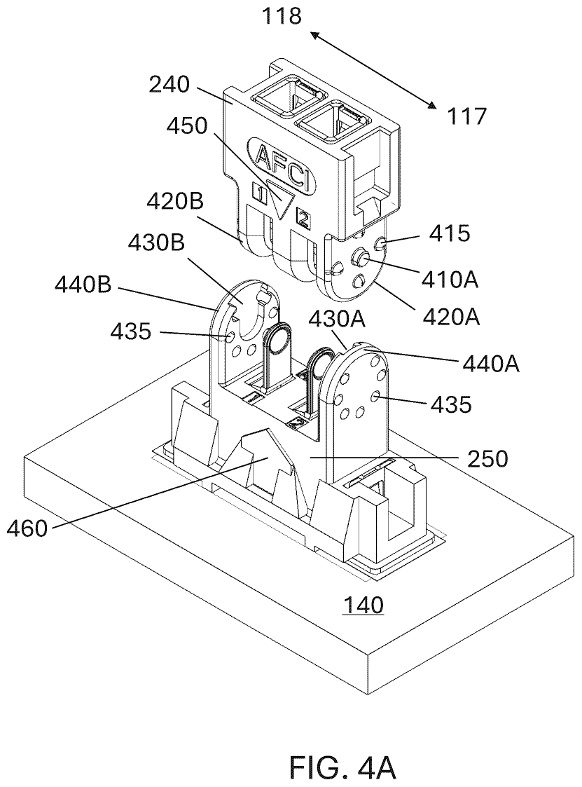

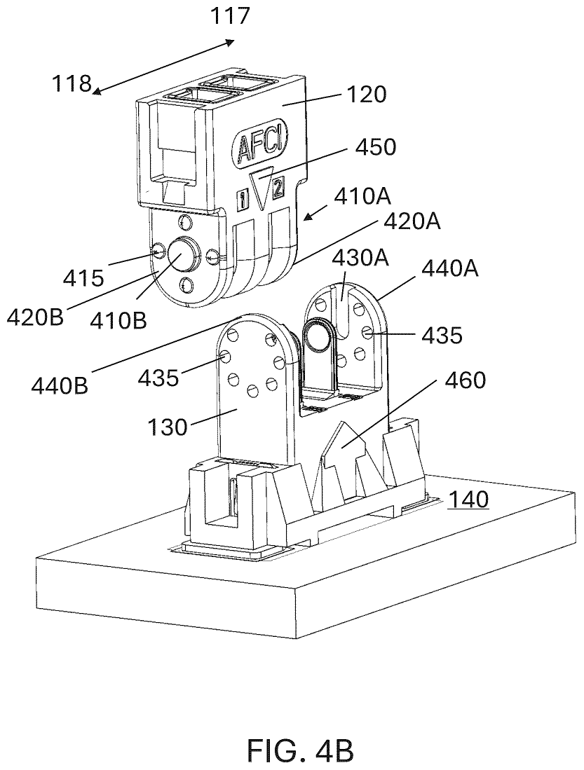

FIGS. 4A and 4B show the interconnect housing 240 disengaged from the connector 130 from different perspectives. FIG. 4A shows aspects of the sensor module 125 from a first side 117. The interconnect housing 240 includes an extending arm 420A from the interconnect housing 240 that extends toward the connector 130 on a first side 117 and an extending arm 420B extending from the interconnect housing 240 toward the connector 130 on a second side 118, opposite the first side 117. The extending arm 420A has a disk 410A that protrudes from the extending arm 420A and acts as a connector engagement element on the first side 117, and the extending arm 420B has a disk 410B (visible in FIG. 4B) that protrudes from the extending arm 420B and acts as a connector engagement element on the second side 118. The extending arms 420A, 420B also have protruding bumps 415 that may facilitate locking the interconnect 120 at a particular tilt angle relative to the connector 130 as further discussed.

The connector 130 has an extending arm 440A extending toward the interconnect 120 on the first side 117 and an extending arm 440B extending toward the interconnect 120 on the second side 118. The extending arm 440B has a groove 430B and the extending arm 440A has a groove 430A (visible in FIG. 4B). Each of the grooves 430A, 430B has an open end and a rounded, closed end, as shown. The extending arms 440A, 440B of the connector housing 250 also have holes 435 that may engage with the bumps 415 on the extending arms 420A, 420B of the interconnect housing 240.

FIG. 4B shows aspects of the sensor module 125 from the second side 118. The disk 410A protruding from the extending arm 420A of the interconnect housing 240 slides into the open end of the groove 430A in the extending arm 440A of the connector housing 250, and the disk 410B on the extending arm 420B of the interconnect housing 240 slides into the open end of the groove 430B of the extending arm 440B of the connector housing 250. The extending arms 440A, 440B from the connector housing 250 may flex (e.g., outward) to accommodate insertion of the disks 410A, 410B into the grooves 430A, 430B, respectively. When the interconnect 120 is tilted relative to the connector 130 as shown in FIGS. 1B, 1C, and 1D, for example, the interconnect housing 240 rotates relative to the connector housing 250, facilitated by rotation of the disks 410A, 410B of the interconnect 120 at the rounded ends of the grooves 430A, 430B of the connector 130, respectively. Flexion of the extending arms 440A, 440B of the connector housing 250 may also facilitate engagement of the bumps 415 of the extending arms 420A, 420B of the interconnect housing 240 in holes 435 in the extending arms 440A, 440B of the connector housing 250 to lock the interconnect 120 at a particular tilt angle relative to the connector 130.

The disk 410A on the first side 117 of the interconnect housing 240 is smaller than the disk 410B on the second side 118 of the interconnect housing 240. Correspondingly, the groove 430A on the first side 117 of the connector housing 250 is narrower than the groove 430B on the second side 118 of the connector housing 250. Thus, the disk 410B on the second side 118 of the interconnect housing 240 is too large to fit in the groove 430A on the first side 117 of the connector housing 250. As such, a person coupling the interconnect 120 to the connector 130 will readily know whether the interconnect 120 is oriented correctly relative to the connector 130. That is, the asymmetric sizing of the disks 410A, 410B on the interconnect housing 240 and the grooves in the connector housing 250 facilitate a keyed coupling between the interconnect 120 and the connector 130. The indicator 450 on the interconnect housing 240 and the indicator 460 on the connector housing 250 also aid in quickly and correctly coupling the interconnect 120 to the connector 130.

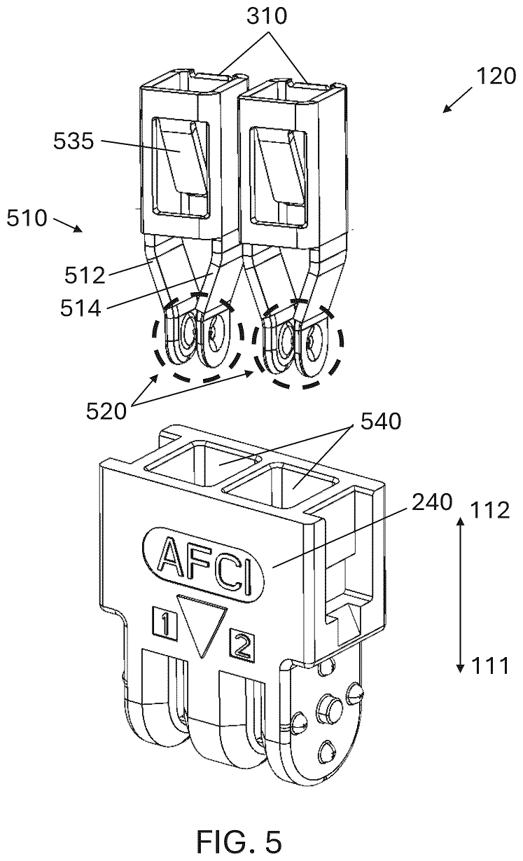

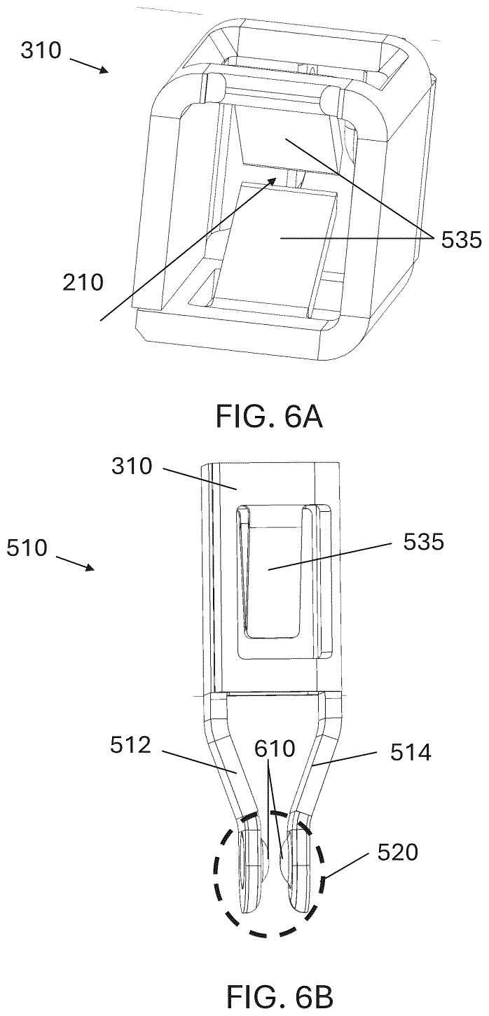

FIG. 5 shows the conductive elements 510 of the interconnect 120 outside the interconnect housing 240. Each of the conducting elements 510 includes a receptacle 310 on the second end 112 to electrically connect the interconnect 120 with one or more leads 210 of the sensor 110. The receptacles include tabs 535 to securely hold the leads 210, as further discussed with reference to FIG. 6A. Each of the conducting elements 510 also includes a mating contact portion 520 on the first end 111 to electrically connect the interconnect 120 with the connector 130. The mating contact portion 520 is formed by a first arm 512 and a second arm 514 that extend from the receptacle 310, as further discussed with reference to FIG. 6B. The interconnect housing 240 includes compartments 540 that respectively accommodate the receptacles 310 and mating contact portions of the conductive elements 510.

FIG. 6A is a view into a receptacle 310 of a conductive element 510 of the interconnect 120. The direction of insertion of one or more leads 210 into the receptacle 310 is indicated. Tabs 535 extend into the receptacle 310 and may be flexible. That is, the tabs 535 may be deflected out in opposite directions toward a perimeter of the receptacle 310 when one or more leads 210 are plugged in. Following the insertion of the one or more leads 210, the tabs may spring back toward the center and hold the leads 210 within the receptacle 310. This direct connection between the leads 210 of the sensor 110 and the receptacles 310 of the interconnect 120, without requiring an additional process such as crimping, soldering, or wiring, increase the ease with which the sensor 110 or other pluggable modular component may be engaged and disengaged from the sensor module 125 or, more generally, the modular subassembly including the interconnect 120 and connector 130.

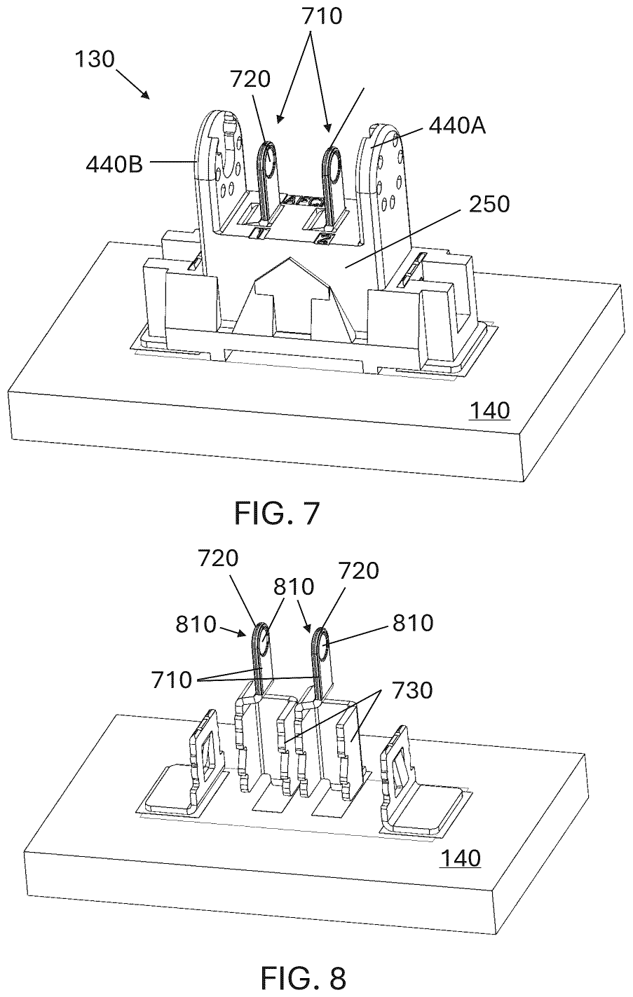

FIG. 6B shows a conductive element 510 the interconnect 120. The first arm 512 and second arm 514 extending from the receptacle 310 are closer at the first end 111, opposite the end with the receptacle 310, and form the mating contact portion 520 of the conductive element 510 together. Conductive bumps 610 in the mating contact portion 520 for mating with mating contact portion 720 (FIG. 7) of the connector 130 are indicated.

FIG. 7 is a perspective view of the connector 130 of the sensor assembly 100. Between the first extending arm 440A and the second extending arm 440B of the connector housing 250, the connector 130 has conductive elements 710 for electrical connection with the interconnect 120 and, more particularly, the conductive elements 510 of the interconnect 120. Each of the conductive elements 710 of the connector 130 includes a mating contact portion 720.

FIG. 8 is a perspective view of the connector 130 with the connector housing 250 removed. In this view, the tail portion 730 of each conductive element 710 of the connector 130 is also visible. The tail portions 730 form an electrical connection between the connector 130 and the PCB 140. Each of the mating contact portions 720 includes conductive pads 810 on either side for engagement with the conductive bumps 610 of the conductive elements 510 of the interconnect 120. That is, the conductive bump 610 of a first arm 512 of a conductive element 510 engages with a conductive pad 810 on one side of a mating contact portion 720 of a conductive element 710, and the conductive bump 610 of a second arm 514 of the same conductive element 510 engages with a conductive pad 810 on the opposite side of the same mating contact portion 720.

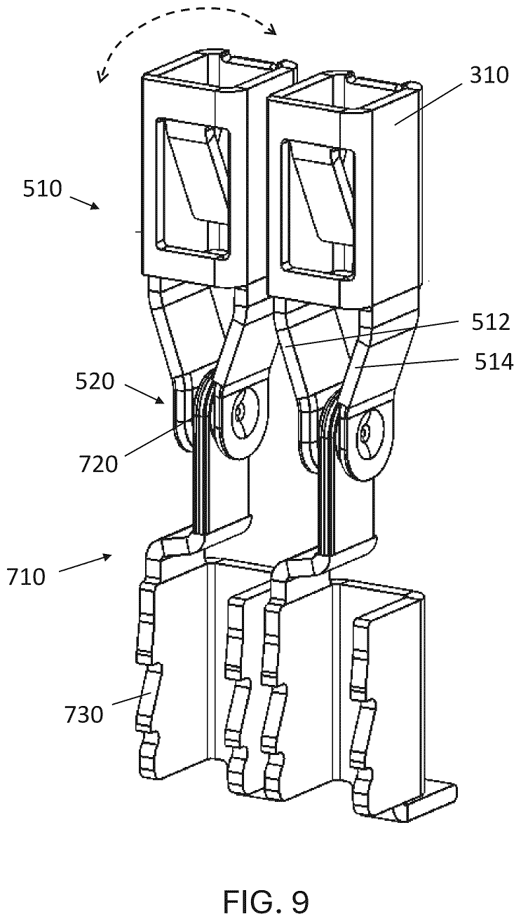

FIG. 9 illustrates electrical connections between the interconnect 120 and the connector 130. Electrical connection between the mating contact portion 520 of each conductive element 510 of the interconnect 120 and the mating contact portion 720 of a corresponding conductive element 710 of the connector 130 is shown. The conductive bumps 610 of the first arm 512 and the second arm 514 of each conductive element 510 of the interconnect 120 engage within the rounded, indented conductive pads 810 on opposite sides of a corresponding conductive element 710 of the connector 130. When the interconnect 120 is tilted relative to the connector 130 as shown in FIGS. 1B, 1C, and 1D, for example, the conductive elements 510 of the interconnect 120 rotate relative to the conductive elements 710 of the connector 130, as indicated by the dashed arc, facilitated by rotation of the conductive bumps 610 of the conductive elements 510 within the conductive pads 810 of the conductive elements 710.

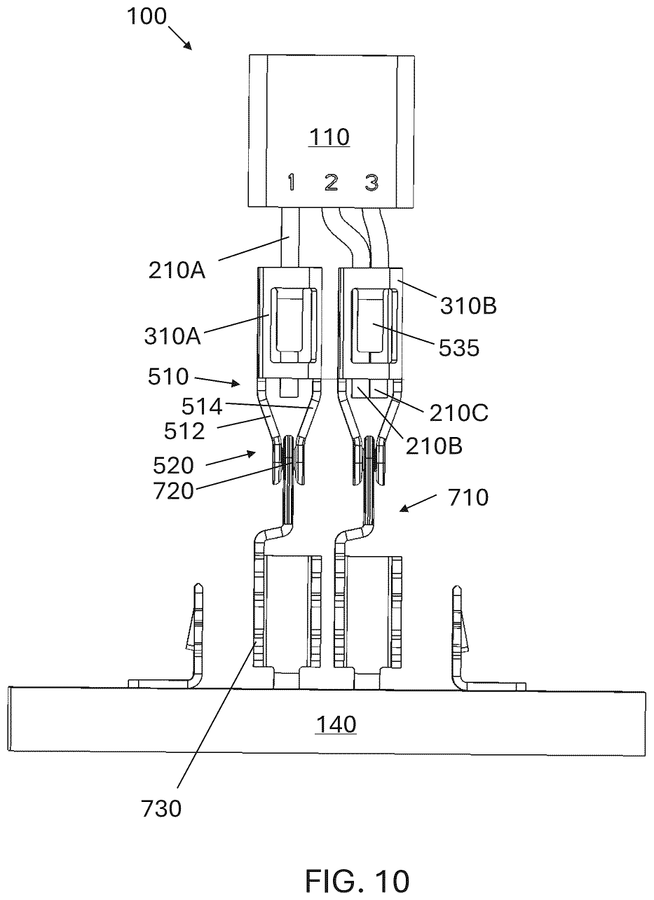

FIG. 10 shows aspects of the sensor assembly 100 with the interconnect housing 240 and the connector housing 250 removed. The exemplary sensor 110 with leads 210A, 210B, 210C may be a temperature sensor. By plugging the lead 210A into one receptacle 310A and the other two leads 210B, 210C into the other receptacle 310B, current flow may be proportional to temperature, facilitating measurement of ambient temperature at a selected height above the PCB 140. Different types of sensors 110 may accommodated by the sensor module 125 based on modifying the openings 230 in the interconnect cover 220 according to the number of leads of a given sensor 110. For example, while two leads 210B, 210C are used for temperature sensing, three leads may be used for humidity thermal sensing, four leads may be used for pressure sensing, and seven leads may be used for combined sensor performing pressure-temperature-altitude sensing.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

According to some exemplary embodiments, other attachment technologies and techniques may be used to connect a sensor 110 or other pluggable modular component to the interconnect 120 and/or to connect the interconnect 120 in a pivotable arrangement with the connector 130. For example, the sensor 110 may be connected to the interconnect 120 via press fit, also referred to as pressed fit or interference fit, rather than through the tabs 535 within the receptacles 310. As another example, the interconnect 120 may be connected to the connector 130 via slip fit.

According to some exemplary embodiments, a sensor assembly 100 may accommodate a sensor or other pluggable modular component other than a temperature sensor, humidity thermal sensor, pressure sensor, or temperature altitude sensor, as noted above. For example, the sensor assembly 100 may accommodate a smoke sensor or moisture sensor.

According to some exemplary embodiments, a method of assembling a sensor assembly 100 according to some embodiments may include obtaining a connector 130 for mounting on a PCB 140 and may include mounting the connector 130 on the PCB 140. Assembling the sensor assembly 100 may also include connecting an interconnect 120 to the connector 130. Connecting the interconnect 120 to the connector 130 may include the interconnect 120 being pivotable relative to the connector 130. Connecting the interconnect 120 to the connector 130 may include orienting the interconnect 120 in a correct orientation relative to the connector 130, the correct orientation being an only orientation in which an interconnect housing 240 couples to a connector housing 250. The interconnector 120 may be selected to accommodate leads of a particular type of sensor 110 or other pluggable modular component in receptacles of the interconnect 120.

All definitions, as defined and used herein, should be understood to control over dictionary definitions, definitions in documents incorporated by reference, and/or ordinary meanings of the defined terms.

Terms signifying direction, such as “upwards” and “downwards” or front and back were used in connection with some embodiments. These terms were used to signify direction based on the orientation of components illustrated or connection to another component, such as a surface of a printed circuit board to which a termination assembly is mounted or the mating face of a connector. It should be understood that electronic components may be used in any suitable orientation. Accordingly, terms of direction should be understood to be relative, rather than fixed to a coordinate system perceived as unchanging, such as the earth's surface.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

### EXAMPLES

In some examples, a sensor module may be configured to receive a sensor for one or more characteristics associated with an electronic assembly comprising a printed circuit board (PCB), wherein the sensor comprises a plurality of leads. The sensor module may comprise a connector configured to be mounted on the PCB. The connector may comprise a connector housing and a first plurality of conductive elements held by the connector housing. Each of the first plurality of conductive elements may comprise a tail configured for electrical connection to the PCB and a mating contact portion. The sensor module may comprise an interconnect configured to receive the plurality of leads of the sensor, wherein the interconnect is pivotably coupled to the connector. The interconnect may comprise an interconnect housing pivotally coupled to the connector housing and a second plurality of conductive elements held by the interconnect housing. Each of the second plurality of conductive elements may comprise a mating contact portion configured to pivotally engage a mating contact portion of a respective conductive element of the first plurality of conductive elements and a receptacle configured to receive at least one lead among the plurality of leads of the sensor.

Optionally, such a sensor module may include one or more of the following features:
The interconnect may comprise a first end and a second end, opposite the first end. The interconnect housing may be pivotally coupled to the connector housing at the first end of the interconnect. The interconnect may be configured to receive the sensor at the second end.
The interconnect housing may have a face at the second end, and the face may comprise a plurality of openings. Each of the plurality of openings may be aligned with a respective receptacle of a conductive element of the second plurality of conductive elements.
One of the plurality of openings on the face of the interconnect housing may be sized to accommodate one of the plurality of leads of the sensor. Another of the plurality of openings may be sized to accommodate two or more of the plurality of leads of the sensor.
The interconnect housing may comprise a body portion and a cover. The body portion may comprise a cavity with the receptacles of the second plurality of conductive elements disposed within the body portion and the cover may comprise the face.
The cover of the body portion may be latched to the body portion and separable from the body.
Each of the receptacles of the second plurality of conductive elements may comprise at least three sides. Each of the mating contact portions of the second plurality of conductive elements may comprise a first arm and an opposed second arm. For each of the second plurality of conductive elements, the first arm may extend from a first side of the at least three sides of the receptacle to the mating contact portion. The second arm of the second plurality of conductive elements may extend from a second side of the at least three sides of the receptacle, opposite the first side, to the mating contact portion. The receptacle may further comprise a tab, configured to engage a sensor lead, cut in a side of the at least three sides of the receptacle.
The mating contact portion of each of the second plurality of conductive elements may be a portion of the first arm and a portion of the second arm that are closest to each other.
The mating contact portion of each of the first plurality of conductive elements may be configured to be engaged in the mating contact portion of a corresponding one of the second plurality of conductive elements, between the portion of the first arm and the portion of the second arm.
The mating contact portion of each of the second plurality of conductive elements may be configured to rotate around an axis through the mating contact portion of a corresponding one of the first plurality of conductive elements.
The interconnect may comprise a first connector engagement feature on a first side of the first end of the interconnect. The interconnect may comprise a second connector engagement feature, of a different size than the first connector engagement feature, on a second side, opposite the first side, of the first end of the interconnect.
The connector may comprise a first interconnect engagement feature on a first side of the connector, and a second interconnect engagement feature, of a different size than the first interconnect engagement feature, on a second side, opposite the first side, of the connector.
The first connector engagement feature may be a first disk protruding from a first extending arm of the interconnect housing. The second connector engagement feature may be a second disk, with a smaller diameter than the first disk, protruding from a second extending arm of the interconnect housing.
The first interconnect engagement feature may be a first groove in a first extending arm of the connector housing. The second interconnect engagement feature may be a second groove, smaller than the first groove, in a second extending arm of the connector housing. Each of the first groove and the second groove may have an open end and a rounded closed end.
The first extending arm of the connector housing may be configured to flex to engage the first disk protruding from the first extending arm of the interconnect housing into the open end of the first groove. The second extending arm of the connector housing may be configured to flex to engage the second disk protruding from the second extending arm of the interconnect housing into the open end of the second groove. The second groove may be sized such that only the second disk, and not the first disk, engages in the second groove. The first extending arm and the second extending arm of an interconnect may be configured to pivot based on respective rotation of the first disk in the first groove and the second disk in the second groove.

In some examples, a sensor assembly may comprise a sensor configured to sense one or more characteristics associated with an electronic assembly comprising a printed circuit board (PCB). The sensor assembly may comprise a connector configured to be mounted on the PCB. The sensor assembly may comprise an interconnect configured to receive the sensor and couple to the connector. The interconnect may comprise asymmetrical mating components configured to couple to the connector in only one orientation. The interconnect and the sensor may be configured to tilt relative to the connector.

Optionally, such a sensor assembly may include one or more of the following features:
An interconnect housing may include a first extending arm on a first side and a second extending arm on a second side, opposite the first side, of the interconnect housing. A connector housing may include a first extending arm on a first side and a second extending arm on a second side, opposite the first side, of the connector housing. The first extending arm of the interconnect housing may couple to the first extending arm of the connector housing. The second extending arm of the interconnect housing may couple to the second extending arm of the connector housing.
The first extending arm of the interconnect housing may include a first disk that slides into a first groove in the first extending arm of the connector housing. The second extending arm of the interconnect housing may include a second disk that slides into a second groove in the second extending arm of the connector housing. The first disk may be larger than the second disk and the second groove is too small to accommodate the first disk.
The first groove may have an open end and a rounded, closed end, and the first disk may slide into the open end of the first groove. The second groove may have an open end and a rounded, closed end, and the second disk may slide into the open end of the second groove.
The interconnect may be configured to tilt relative to the connector based on rotation of the first disk at the rounded, closed end of the first groove and on rotation of the second disk at the rounded, closed end of the second groove.
The interconnect may comprise a first end including the first extending arm and the second extending arm and a second end, opposite the first end. The interconnect housing may have a face at the second end. The face may comprise a plurality of openings, each of the plurality of openings aligned with a respective receptacle among a plurality of receptacles, and each configured to receive at least one lead among a plurality of leads of the sensor.
The connector may include a first plurality of conductive elements. Each of the first plurality of conductive elements may comprise a tail configured for electrical connection to the PCB and a mating contact portion. The interconnect may include a second plurality of conductive elements. Each of the second plurality of conductive elements may comprise a mating contact portion that may be configured to pivotally engage a mating contact portion of a respective conductive element of the first plurality of conductive elements and one of the plurality of receptacles.
The first extending arm and the second extending arm of the interconnect may comprise protruding bumps. The first extending arm and the second extending arm of the connector may comprise holes such that the protruding bumps of the interconnect engage with the holes of the connector to lock the interconnect at a given tilt angle, wherein the given tilt angle may result in a change in height of the sensor above the PCB.
The sensor may be a temperature sensor, humidity sensor, moisture sensor, pressure sensor, or pressure-temperature-altitude sensor.

In some examples, a modular assembly may be configured to receive a modular component. The modular assembly may comprise a connector configured to be mounted on a printed circuit board (PCB), the connector comprising. The connector may comprise a connector housing comprising a first interface coupler on a first side of the connector housing and a second interface coupler on a second side, opposite the first side, of the connector housing. The interconnect may comprise a first end configured to be pivotably coupled to the connector. The interconnect may comprise a second end and may be configured to be coupled to the modular component. An interconnect housing may have a first connector coupler on a first side of an interface housing and a second connector coupler on a second side, opposite the first side, of the interface housing. A first interconnect coupler of the connector housing may be sized to accommodate the first connector coupler of the interface housing. The second interface coupler of the connector housing may be sized to accommodate the second connector coupler of the interface housing such that the interface housing is configured to slidably couple to the connector housing in only one orientation.

Optionally, such a modular assembly may include one or more of the following features:
The first interface coupler may be a first groove with an open end and a rounded, closed end. The second interface coupler may be a second groove with an open end and a rounded, closed end. The first connector coupler may be a first disk, and the second connector coupler may be a second disk, smaller than the first disk. The second groove may be too small to accommodate the first disk.
The interface housing may include a first extendable arm on a first side and a second extendable arm on a second side, opposite the first side, of the interface housing. The connector housing may include a first extendable arm on a first side and a second extendable arm on a second side, opposite the first side, of the connector housing.
The first disk may protrude from the first extendable arm of the interface housing. The second disk may protrude from the second extendable arm of the interface housing. The first groove may be in the first extendable arm of the connector housing. The second groove may be in the second extendable arm of the connector housing The interface may couple to the connector only when the first extendable arm of the interface is aligned with the first extendable arm of the connector. The second extendable arm of the interface may be aligned with the second extendable arm of the connector.
The interface may be configured to pivot relative to the connector based on rotation of the first disk in the rounded end of the first groove and rotation of the second disk in the rounded end of the second groove.
The first extendable arm and the second extendable arm of the interface may include protruding bumps. The first extending arm and the second extending arm of the connector may comprise holes such that the protruding bumps of the interconnect engage with the holes of the connector to lock the interconnect at a given pivot angle.
The connector may comprise a first plurality of conductive elements. Each of the first plurality of conductive elements may comprise a tail configured for electrical connection to the PCB and a mating contact portion. The interface may comprise a second plurality of conductive elements. Each of the second plurality of conductive elements may comprise a mating contact portion configured to pivotally engage a mating contact portion of a respective conductive element of the first plurality of conductive elements. The interface may comprise a receptacle configured to receive at least one lead among the plurality of leads of a sensor coupled to the interconnect.
Each of the receptacles of the second plurality of conductive elements may comprise at least three sides. Each of the mating contact portions of the second plurality of conductive elements may comprise a first arm and an opposed second arm. For each of the second plurality of conductive elements, the first arm may extend from a first side of the at least three sides of the receptacle to the mating contact portion. The second arm of the second plurality of conductive elements may extend from a second side of the at least three sides of the receptacle, opposite the first side, to the mating contact portion. The receptacle of the second plurality of conductive elements may further comprises a tab, configured to engage a sensor lead, cut in a side of the at least three sides of the receptacle.
The mating contact portion of each of the second plurality of conductive elements may be a portion of the first arm and a portion of the second arm that are closest to each other.
The mating contact portion of each of the first plurality of conductive elements may be configured to be engaged in the mating contact portion of a corresponding one of the second plurality of conductive elements, between the portion of the first arm and the portion of the second arm.
The mating contact portion of each of the second plurality of conductive elements may be configured to rotate around the mating contact portion of a corresponding one of the first plurality of conductive elements.

What is claimed is:

1. A sensor module configured to receive a sensor for one or more characteristics associated with an electronic assembly comprising a printed circuit board (PCB), wherein the sensor comprises a plurality of leads and the sensor module comprises:
a connector configured to be mounted on the PCB, the connector comprising:
a connector housing; and
a first plurality of conductive elements held by the connector housing, each of the first plurality of conductive elements comprising a tail configured for electrical connection to the PCB and a mating contact portion; and
an interconnect configured to receive the plurality of leads of the sensor, wherein the interconnect is pivotably coupled to the connector, the interconnect comprising:
an interconnect housing pivotally coupled to the connector housing; and
a second plurality of conductive elements held by the interconnect housing, each of the second plurality of conductive elements comprising a mating contact portion configured to pivotally engage a mating contact portion of a respective conductive element of the first plurality of conductive elements and a receptacle configured to receive at least one lead among the plurality of leads of the sensor.

2. The sensor module according to claim 1, wherein:
the interconnect comprises a first end and a second end, opposite the first end;
the interconnect housing is pivotally coupled to the connector housing at the first end of the interconnect; and
the interconnect is configured to receive the sensor at the second end.

3. The sensor module according to claim 2, wherein the interconnect housing has a face at the second end, and the face comprises a plurality of openings, wherein:
each of the plurality of openings is aligned with a respective receptacle of a conductive element of the second plurality of conductive elements,
one of the plurality of openings is sized to accommodate one of the plurality of leads of the sensor, and
another of the plurality of openings is sized to accommodate two or more of the plurality of leads of the sensor.

4. The sensor module according to claim 3, wherein:
the interconnect housing comprises:
a body portion, a cover,
a first connector engagement feature on a first side of the first end of the interconnect, and
a second connector engagement feature, of a different size than the first connector engagement feature, on a second side, opposite the first side, of the first end of the interconnect;
the body portion comprises a cavity with the receptacles of the second plurality of conductive elements disposed within the body portion; and
the cover comprises the face, wherein the cover is latched to the body portion and separable from the body.

5. The sensor module according to claim 4, wherein:
each of the receptacles of the second plurality of conductive elements comprises at least three sides;
each of the mating contact portions of the second plurality of conductive elements comprises a first arm and an opposed second arm; and
for each of the second plurality of conductive elements:
the first arm extends from a first side of the at least three sides of the receptacle to the mating contact portion;
the second arm extends from a second side of the at least three sides of the receptacle, opposite the first side, to the mating contact portion; and
the receptacle further comprises a tab, configured to engage a sensor lead, cut in a side of the at least three sides of the receptacle.

6. The sensor module according to claim 5, wherein the mating contact portion of each of the second plurality of conductive elements rotates around an axis through the mating contact portion of a corresponding one of the first plurality of conductive elements.

7. The sensor module according to claim 6, wherein the connector comprises
a first interconnect engagement feature on a first side of the connector wherein the first interconnect engagement feature is a first groove in a first extending arm of the connector housing,
a second interconnect engagement feature, of a different size than the first interconnect engagement feature, on a second side, opposite the first side, of the connector, wherein the second interconnect engagement feature is a second groove, smaller than the first groove, in a second extending arm of the connector housing, and
each of the first groove and the second groove have an open end and a rounded closed end.

8. The sensor module according to claim 7, wherein:
the first extending arm of the connector housing is configured to flex to engage a first disk protruding from the first extending arm of the interconnect housing into the open end of the first groove,
the second extending arm of the connector housing is configured to flex to engage a second disk protruding from the second extending arm of the interconnect housing into the open end of the second groove,
the second groove is sized such that only the second disk, and not the first disk, engages in the second groove, and
the first extending arm and the second extending arm of an interconnect pivot based on respective rotation of the first disk in the first groove and the second disk in the second groove.

9. A sensor assembly comprising:
a sensor configured to sense one or more characteristics associated with an electronic assembly comprising a printed circuit board (PCB);
a connector configured to be mounted on the PCB; and
an interconnect configured to receive the sensor and couple to the connector, wherein:
the interconnect and the connector are configured to tilt relative to the connector such that the height of the sensor relative to the PCB to which the sensor assembly is mounted can be adjusted by changing the tilt of the interconnect relative to the connector.

10. The sensor assembly according to claim 9, further comprising:
an interconnect housing including a first extending arm on a first side and a second extending arm on a second side, opposite the first side, of the interconnect housing; and
a connector housing including a first extending arm on a first side and a second extending arm on a second side, opposite the first side, of the connector housing, wherein the first extending arm of the interconnect housing couples to the first extending arm of the connector housing and the second extending arm of the interconnect housing couples to the second extending arm of the connector housing.

11. The sensor assembly of claim 10, wherein:
the first extending arm of the interconnect housing includes a first disk that slides into a first groove in the first extending arm of the connector housing, wherein:
the first groove has an open end and a rounded, closed end, and
1. the first disk slides into the open end of the first groove;
the second extending arm of the interconnect housing includes a second disk that slides into a second groove in the second extending arm of the connector housing, wherein:
the second groove has an open end and a rounded, closed end, and
2. the second disk slides into the open end of the second groove; and
the first disk is larger than the second disk and the second groove is too small to accommodate the first disk.

12. The sensor assembly of claim 11, wherein the interconnect is configured to tilt relative to the connector based on rotation of the first disk at the rounded, closed end of the first groove and on rotation of the second disk at the rounded, closed end of the second groove.

13. The sensor assembly of claim 12, wherein:
the interconnect comprises a first end including the first extending arm and the second extending arm and a second end, opposite the first end; and
the interconnect housing has a face at the second end, and the face comprises a plurality of openings, each of the plurality of openings aligned with a respective receptacle among a plurality of receptacles, each configured to receive at least one lead among a plurality of leads of the sensor.

14. The sensor assembly of claim 13, wherein:
the connector includes a first plurality of conductive elements, each of the first plurality of conductive elements comprising a tail configured for electrical connection to the PCB and a mating contact portion; and
the interconnect includes a second plurality of conductive elements, each of the second plurality of conductive elements comprising a mating contact portion configured to pivotally engage a mating contact portion of a respective conductive element of the first plurality of conductive elements and one of the plurality of receptacles.

15. The sensor assembly of claim 12, wherein:
the first extending arm and the second extending arm of the interconnect comprise protruding bumps; and
the first extending arm and the second extending arm of the connector comprise holes such that the protruding bumps of the interconnect engage with the holes of the connector to lock the interconnect at a given tilt angle, wherein the given tilt angle results in a change in height of the sensor above the PCB.

16. A modular assembly configured to receive a modular component, the modular assembly comprising:
a connector configured to be mounted on a printed circuit board (PCB), the connector comprising:
a connector housing comprising a first interface coupler on a first side of the connector housing and a second interface coupler on a second side, opposite the first side, of the connector housing; and
an interconnect comprising:
a first end configured to be pivotably coupled to the connector;
a second end configured to be coupled to the modular component; and
an interconnect housing comprising a first connector coupler on a first side of an interface housing and a second connector coupler on a second side, opposite the first side, of the interface housing, wherein:
a first interconnect coupler of the connector housing is sized to accommodate the first connector coupler of the interface housing and the second interface coupler of the connector housing is sized to accommodate the second connector coupler of the interface housing such that the interface housing is configured to slidably couple to the connector housing in only one orientation.

17. The modular assembly of claim 16, wherein:
the first interface coupler is a first groove with an open end and a rounded, closed end and the second interface coupler is a second groove with an open end and a rounded, closed end; and
the first connector coupler is a first disk, the second connector coupler is a second disk, smaller than the first disk, and the second groove is too small to accommodate the first disk.

18. The modular assembly of claim 17, wherein:
the interface housing includes a first extendable arm on a first side and a second extendable arm on a second side, opposite the first side, of the interface housing; and
the connector housing includes a first extendable arm on a first side and a second extendable arm on a second side, opposite the first side, of the connector housing.

19. The modular assembly of claim 18, wherein:
the first disk protrudes from the first extendable arm of the interface housing and the second disk protrudes from the second extendable arm of the interface housing;
the first groove is in the first extendable arm of the connector housing and the second groove is in the second extendable arm of the connector housing; and
the interface couples to the connector only when the first extendable arm of the interface is aligned with the first extendable arm of the connector and the second extendable arm of the interface is aligned with the second extendable arm of the connector.

20. The modular assembly of claim 18, wherein the interface is configured to pivot relative to the connector based on rotation of the first disk in the rounded end of the first groove and rotation of the second disk in the rounded end of the second groove.

21. The modular assembly of claim 18, wherein:
the first extendable arm and the second extendable arm of the interface include protruding bumps; and
the first extending arm and the second extending arm of the connector comprise holes such that the protruding bumps of the interconnect engage with the holes of the connector to lock the interconnect at a given pivot angle.
